(19) United States
(12) Patent Application Publication
(10) Pub. No.: US 2013/0201963 A1
(43) Pub. Date: Aug. 8, 2013

(54) RECEIVING GSM TIMING INFORMATION FROM TD-SCDMA BASE STATION TO FACILITATE TD-SCDMA TO GSM WIRELESS HANDOVER

(71) Applicants: Tom Chin, San Diego, CA (US); Guangming Shi, San Diego, CA (US); Kuo-Chun Lee, San Diego, CA (US)

(72) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/516,656

(22) PCT Filed: Apr. 26, 2010
(86) PCT No.: PCT/US2010/032442

§ 371 Date: Oct. 4, 2012

Related U.S. Application Data
(60) Provisional application No. 61/296,202, filed on Jan. 19, 2010.

(51) Int. Cl. H04W 72/04

(52) U.S. Cl. CPC H04W 72/0446
USPC 370/335

(57) ABSTRACT

Wireless communication is implemented by a multi-mode user equipment (UE). The method includes receiving cross reference timing information indicating a relationship between Time Division-Synchronous Code Division Multiple Access (TD-SCDMA) timing and GSM timing. The method further includes acquiring a Global System for Mobile communications (GSM) signal from at least one GSM cell, based on the cross reference timing information. The UE can handover to a selected GSM cell based on the measurements of the acquired GSM cell(s).

### CROSS-REFERENCE TO RELATED APPLICATION

This application claims the benefit of U.S. Provisional Patent Application No. 61/296,202, entitled “TD-SCDMA TO GSM WIRELESS HANDOVER,” filed on Jan. 19, 2010, which is expressly incorporated by reference herein in its entirety.

### BACKGROUND

1. Field

Aspects of the present disclosure relate generally to wireless communication systems, and more particularly, to handovers from Time Division-Synchronous Code Division Multiple Access (TD-SCDMA) cells to Global System for Mobile communications (GSM) cells.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In the initial deployment of TD-SCDMA systems, it is expected that the TD-SCDMA network will not cover all geographical areas and therefore mobile devices (or user equipment (UE)) will handover from TD-SCDMA cells to GSM cells to maintain communications. To reduce the service disruption and to select the best GSM cell for handover, the UE performs measurement on neighboring GSM cells for signal strength, frequency and timing, and acquires BSIC (Base Station Identity Code) information.

This disclosure proposes methods to speed up the GSM cell measurement for a multimode terminal, such as a TD-SCDMA/GSM device.

### SUMMARY

According to an aspect of the disclosure, a method of wireless communication implemented by a multi-mode user equipment (UE) includes receiving a message indicative of a timing relationship between a Global System for Mobile communications (GSM) frame and a Time Division-Synchronous Code Division Multiple Access (TD-SCDMA) frame.

In another aspect, a method of wireless communication, implemented by a Time Division-Synchronous Code Division Multiple Access (TD-SCDMA) Node B, includes obtaining a timing relationship between a GSM frame and a TD-SCDMA frame; and transmitting a message indicative of the timing relationship between the GSM frame and the TD-SCDMA frame.

In yet another aspect, a user equipment (UE) of a time division-synchronous code division multiple access (TD-SCDMA) system includes at least one processor configured to receive a message indicative of a timing relationship between a Global System for Mobile communications (GSM) frame and a Time Division-Synchronous Code Division Multiple Access (TD-SCDMA) frame; and a memory coupled to the processor(s).

In still another aspect, a Node B of a time division-synchronous code division multiple access (TD-SCDMA) system includes at least one processor configured to obtain a timing relationship between a GSM frame and a TD-SCDMA frame; and to transmit a message indicative of the timing relationship between the GSM frame and the TD-SCDMA frame. The Node B also has a memory coupled to the processor(s).

In another aspect, a computer readable medium has program code recorded thereon. The program code receives a message indicative of a timing relationship between a Global System for Mobile communications (GSM) frame and a Time Division-Synchronous Code Division Multiple Access (TD-SCDMA) frame.

In a further aspect, a computer readable medium has program code recorded thereon. The program code obtains a timing relationship between a GSM frame and a TD-SCDMA frame; and transmits a message indicative of the timing relationship between the GSM frame and the TD-SCDMA frame.

In another aspect, an apparatus for wireless communication in a TD-SCDMA system includes means for receiving a message indicative of a timing relationship between a Global System for Mobile communications (GSM) frame and a Time Division-Synchronous Code Division Multiple Access (TD-SCDMA) frame; and means for acquiring a GSM signal from at least one GSM cell based on the message.

In yet another aspect, an apparatus for wireless communication in a TD-SCDMA system includes means for obtaining a timing relationship between a GSM frame and a TD-SCDMA frame, and means for transmitting a message indicative of the timing relationship between the GSM frame and the TD-SCDMA frame.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a block diagram conceptually illustrating the timing of a GSM signal measurement.

FIG. 5 is a diagram conceptually illustrating an exemplary cross referencing between GSM timing and TD-SCDMA timing.

FIG. 6 is a call flow diagram conceptually illustrating exemplary timing acquisition.

FIG. 7 is a functional block diagram conceptually illustrating example blocks executed to implement the functional characteristics of one aspect of the present disclosure.

FIG. 8 is a functional block diagram conceptually illustrating example blocks executed to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

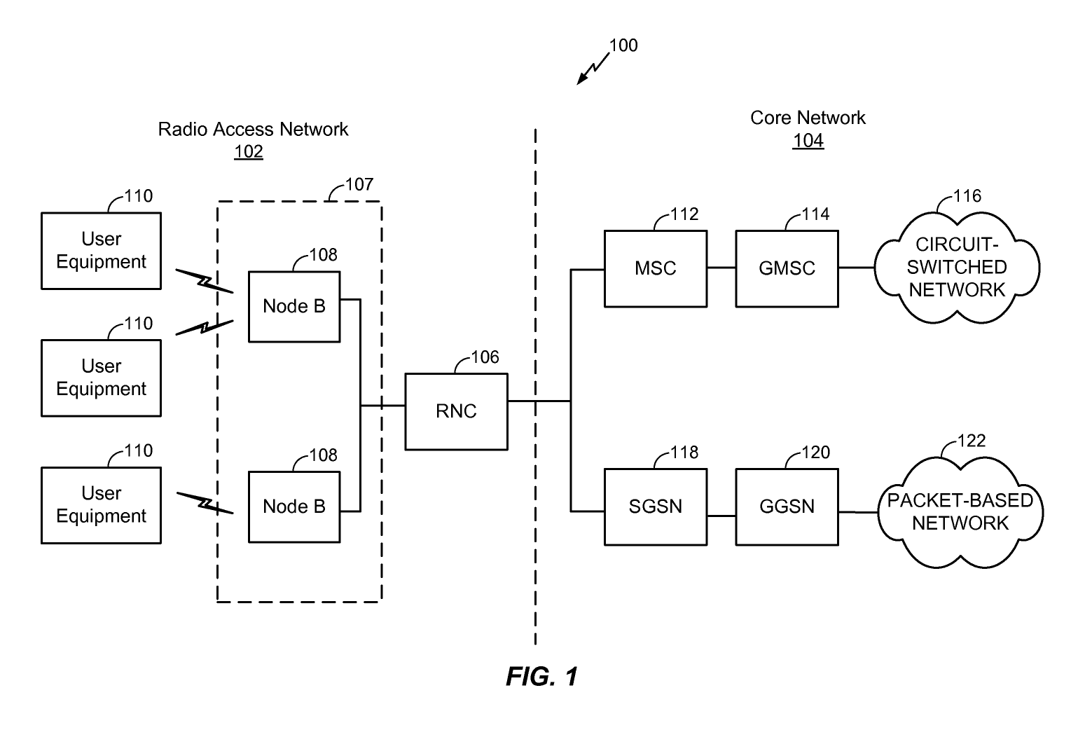

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division

Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

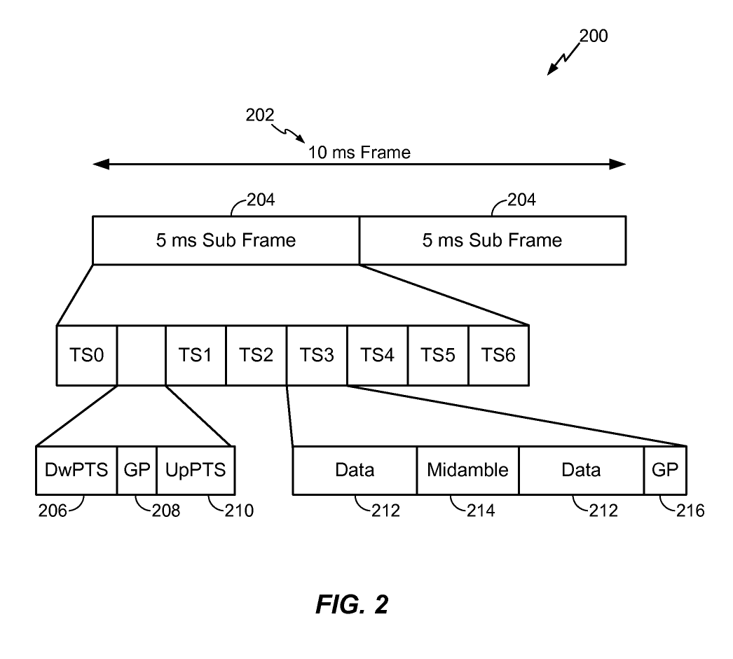

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

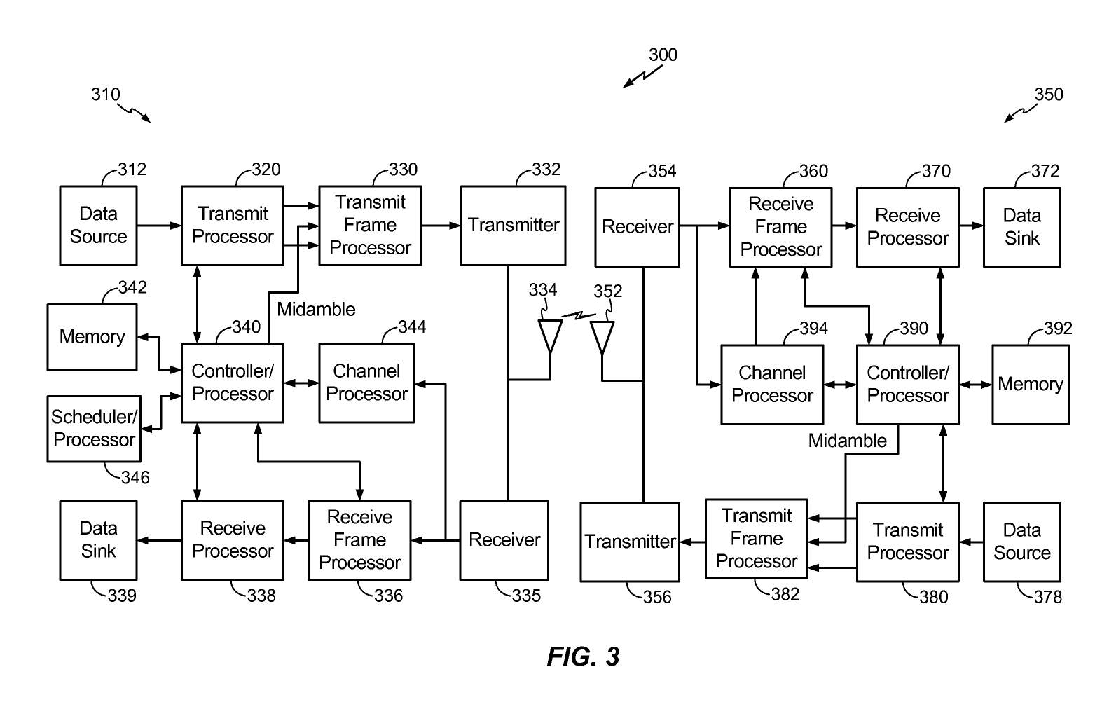

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

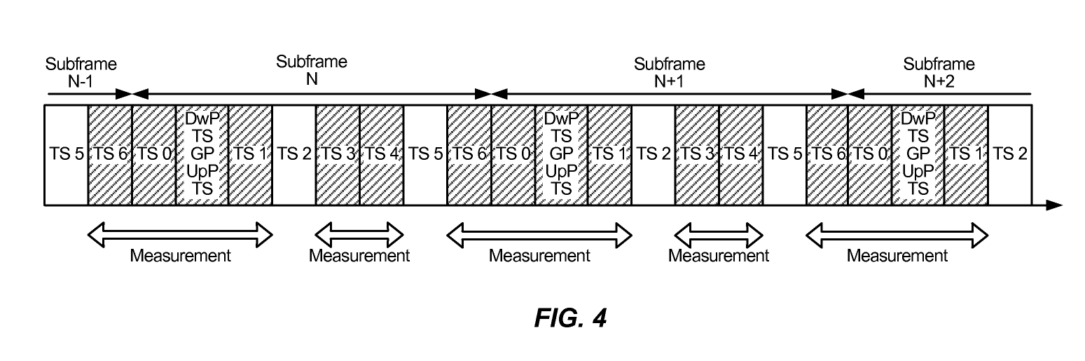

As noted above, a handover from a TD-SCDMA cell to a GSM cell may occur. The TD-SCDMA frame structure can provide some unused downlink and uplink time slots during which the UE can tune to the band and channel of the GSM cell in order to determine which GSM cell to be used for the handover. For example, FIG. 4 shows that the UE can use time slots TS 3-4 and time slots TS 6-1 to perform the GSM measurement.

In measuring GSM cells, the UE acquires the FCCH (Frequency Correction Channel) and the SCH (Synchronization Channel). The Frequency Correction Channel is the frequency pilot of the channel. The Synchronization Channel can carry the Base Station Identity Code (BSIC) information.

The GSM frame cycle for the Frequency Correction Channel and

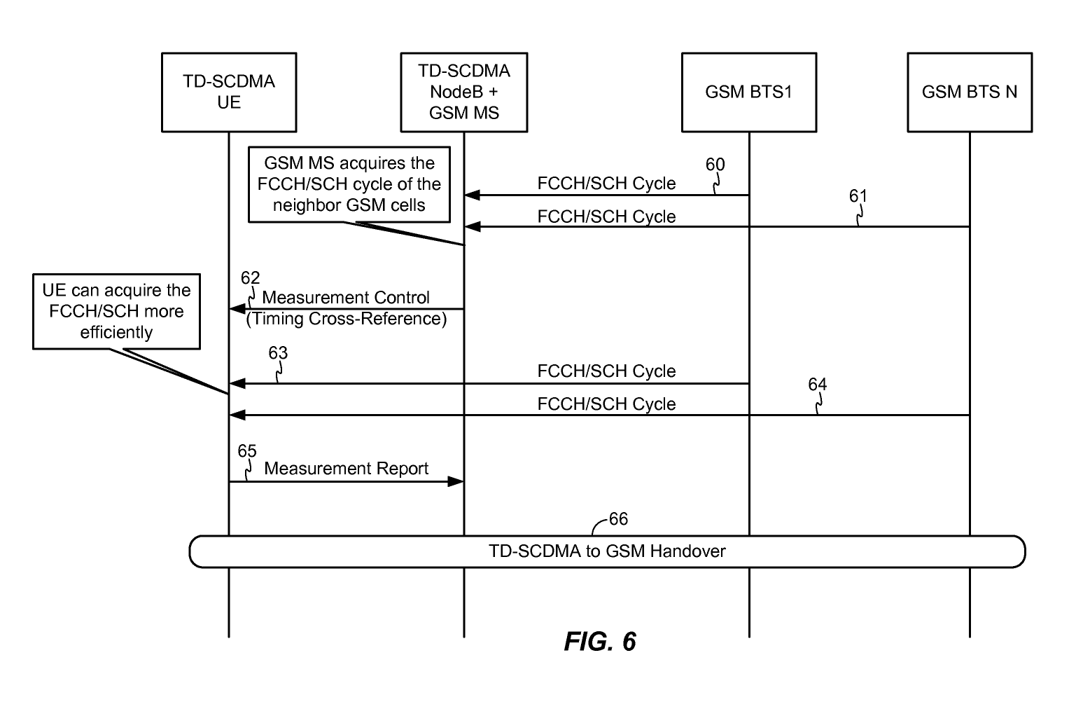

Synchronization Channel consists of 51 frames, each of 8 BPs (Burst Periods). The Frequency Correction Channel is in the first burst period (or BP 0) of frame 0, 10, 20, 30, 40, and the Synchronization Channel is in the first burst period of frame 1, 11, 21, 31, 41. Note that one burst period is 15/26 ms and one frame is 120/26 ms. Therefore, one 51 frame cycle is 235 ms. Also note that the inter-FCCH/SCH period is 10 frames (46.15 ms) or 11 frames (51.77 ms) in FIG. 6 (the last interval of the 51 frame cycle is 11 frames).

To measure the GSM cells, the UE acquires the Frequency Correction Channel in either a 10 or 11 frame interval, and acquires the Synchronization Channel and read the Base Station Identity Code.

However, because the number of TD-SCDMA continuous time slots can be as few as two or three time slots, a very limited time is available to perform measurement of GSM cells. The situation is exacerbated because the measurement time should include enough time for the UE to tune to a GSM channel and tune back to the TD-SCDMA system. Moreover, because the UE is unaware of the GSM system timing, the UE takes the time to search and acquire the timing. Therefore, it takes a long time to measure the neighbor cells. Accordingly, the TD-SCDMA to GSM handover may not respond quickly.

According to an aspect of the present disclosure, the timing acquisition for GSM cell measurement is improved. In one aspect, the Node B includes timing cross reference information in a message sent to the UE. In particular, the new timing cross reference information indicates how the TD-SCDMA timing corresponds to the GSM timing. For example, the next TD-SCDMA subframe frame number (SFN) could be cross referenced to the next frame number and burst period in the FCCH/SCH cycle.

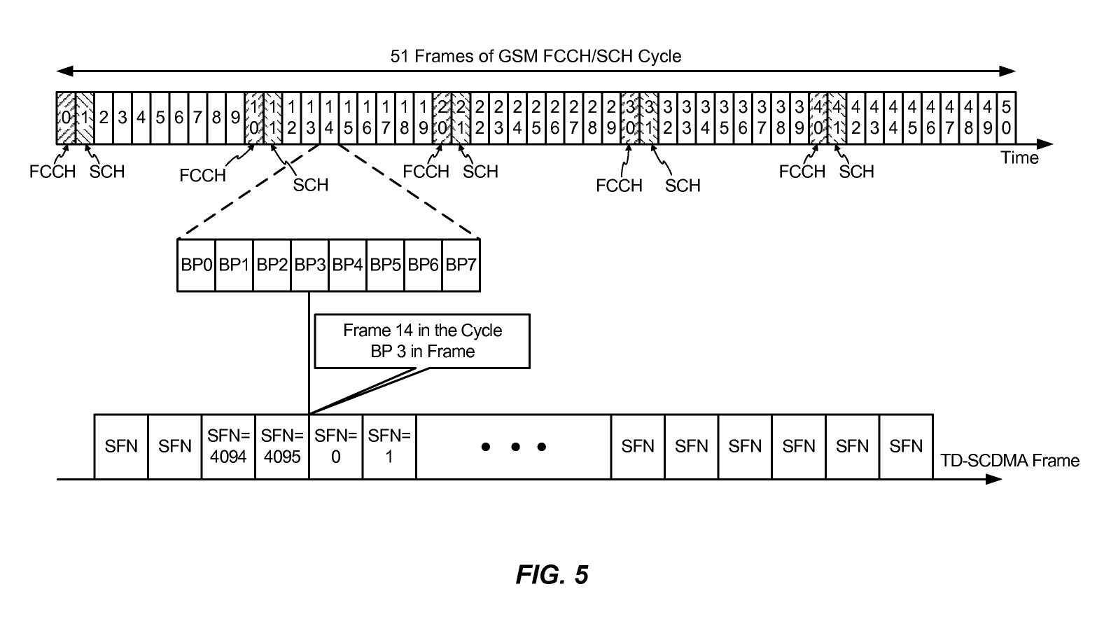

An example will now be explained with reference to FIG. 5. In this example, the TD-SCDMA subframe frame number (SFN)=0 starts during GSM frame 14, burst period (BP) 3. The Node B provides this timing information to the UE so the UE can calculate when the burst periods containing the Frequency Correction Channel and Synchronization Channel will occur. Consequently, the UE can schedule acquisition of the Frequency Correction Channel and Synchronization Channel.

In order for a TD-SCDMA Node B to calculate the timing cross reference information with respect to a GSM cell, in one aspect the TD-SCDMA Node B is installed with one or more GSM mobile stations. The GSM mobile station(s) acquire the GSM FCCH/SCH cycle. The acquired cycle information is compared with the local subframe frame number timing to estimate a time offset. In one aspect, the timing offset is estimated to indicate the frame number of the FCCH/SCH cycle and burst period number when the next local subframe frame number=0 occurs. The TD-SCDMA Node B sends this information, for example in the Measurement Control message, to the UE.

FIG. 6 is a call flow diagram conceptually illustrating exemplary timing acquisition. At time 60, the TD-SCDMA Node B receives timing information from a first neighbor GSM base station (BTS_1). The timing information corresponds to the FCCH/SCH cycle. At time 61, the TD-SCDMA Node B receives timing information from a last neighbor GSM base station (BTS_N) in the coverage area. The timing information also corresponds to the FCCH/SCH cycle. In this example the Node B is installed with a GSM mobile station (MS).

The Node B performs the timing cross reference analysis, and at time 62, sends the information to the multimode TD-SCDMA user equipment (UE). It is noted that multimode includes dual mode. As a result of having the cross reference timing information, at times 63 and 64, the UE can more efficiently acquire the FCCH/SCH information used to select a GSM cell for handover.

At time 65, the UE sends a measurement report to the Node B. This report can indicate the signal strength of the received GSM cell by the UE and associated Base Station Identity Code information. Therefore the TD-SCDMA network can use the report to decide the target GSM cell for handover and request handover to this particular GSM cell with the GSM network. Finally, at time 66, the TD-SCDMA to GSM handover occurs.

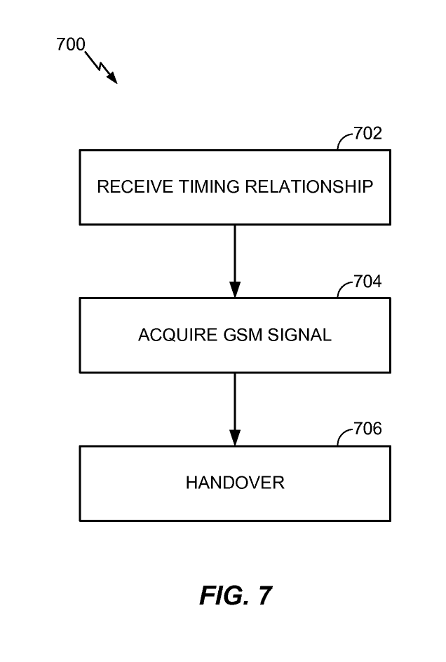

FIG. 7 is a functional block diagram 700 illustrating example blocks executed in conducting wireless communication according to one aspect of the present disclosure. In block 702, a multi-mode user equipment (UE) (which can include a dual mode device) receives a cross reference relationship between a TD-SCDMA timing and a GSM timing. In block 704, the UE acquires a GSM signal from at least one GSM cell, based on the acquired timing relationship. In one aspect, the acquiring enables measurement of strength, frequency and timing (because the handover occurs with some delay after measurement, the timing is reacquired) as well as Base Station Identity Code (BSIC) acquisition. After acquiring the GSM signal, at block 706, the UE hands over to a selected GSM cell based on the measurements of the acquired GSM cell(s).

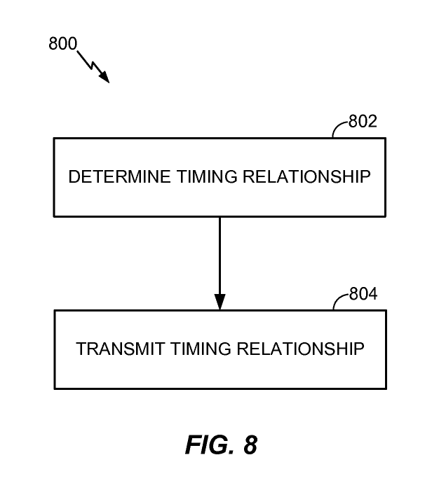

FIG. 8 is a functional block diagram 800 illustrating example blocks executed in conducting wireless communication according to one aspect of the present disclosure. In block 802, the Node B determines a timing relationship between a GSM frame and a TD-SCDMA frame. In one aspect, the GSM timing is obtained using a GSM mobile station, for example installed in the Node B. At block 804 a message is transmitted to a multimode UE indicative of the timing relationship between the GSM frame and the TD-SCDMA frame.

The proposed methods permit multimode UE to measure GSM cells more efficiently in TD-SCDMA to GSM handover. The proposed methods thus improve the handover performance.

In one configuration, the apparatus 350 for wireless communication includes means for receiving a timing relationship, and means for acquiring a GSM signal from at least one GSM cell based on the received timing relationship. In one aspect, the aforementioned means may be the processor(s) 360, 370, 394, 390, 382, 380 configured to perform the functions recited by the aforementioned means. In another aspect, the aforementioned means may be a module or any apparatus configured to perform the functions recited by the aforementioned means.

In one configuration, the apparatus 310 for wireless communication includes means for determining a timing relationship, and means for transmitting the timing relationship. In one aspect, the aforementioned means may be the processor(s) 320, 330, 336, 338, 340, 344, 346 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication implemented by a multi-mode user equipment (UE), comprising
receiving a message indicative of a timing relationship between a Global System for Mobile communications (GSM) frame and a Time Division-Synchronous Code Division Multiple Access (TD-SCDMA) frame.

2. The method of claim 1, further comprising acquiring a GSM signal from at least one GSM cell based on the message.

3. The method of claim 1, in which the timing relationship indicates a frame number in a Frequency Correction Channel (FCCH)/Synchronization Channel (SCH) cycle corresponding to a next TD-SDMA subframe frame number (SFN)=0.

4. The method of claim 2, further comprising handing over to a selected GSM cell based on the acquiring.

5. The method of claim 4, in which the acquiring measures strength, timing, and frequency of the GSM signal.

6. The method of claim 4, in which the acquiring obtains Base Station Identity Code information.

7. A method of wireless communication, implemented by a Time Division-Synchronous Code Division Multiple Access (TD-SCDMA) Node B, comprising:
obtaining a timing relationship between a Global System for Mobile communications (GSM) frame and a TD-SCDMA frame; and
transmitting a message indicative of the timing relationship between the GSM frame and the TD-SCDMA frame.

8. The method of claim 7, in which the timing relationship is obtained using a GSM mobile station.

9. The method of claim 8, in which the GSM mobile station is installed in the Node B.

10. A user equipment (UE) of a time division-synchronous code division multiple access (TD-SCDMA) system, the UE comprising:
at least one processor configured to receive a message indicative of a timing relationship between a Global System for Mobile communications (GSM) frame and a Time Division-Synchronous Code Division Multiple Access (TD-SCDMA) frame; and
a memory coupled to the at least one processor.

11. The UE of claim 10, in which the at least one processor is further configured to acquire a GSM signal from at least one GSM cell based on the message.

12. The UE of claim 10, in which the timing relationship indicates a frame number in a Frequency Correction Channel (FCCH)/Synchronization Channel (SCH) cycle corresponding to a next TD-SDMA subframe frame number (SFN)=0.

13. The UE of claim 11, in which the at least one processor is further configured to hand over to a selected GSM cell based on the acquiring.

14. The UE of claim 13, in which the acquiring measures strength, timing, and frequency of the GSM signal.

15. The UE of claim 13, in which the acquiring obtains Base Station Identity Code information.

16. A Node B of a time division-synchronous code division multiple access (TD-SCDMA) system, the Node B comprising:
at least one processor configured to:
obtain a timing relationship between a Global System for Mobile communications (GSM) frame and a TD-SCDMA frame; and
transmit a message indicative of the timing relationship between the GSM frame and the TD-SCDMA frame; and
a memory coupled to the at least one processor.

17. The Node B of claim 16, further comprising a GSM mobile station that obtains the timing relationship.

18. A computer readable medium having program code recorded thereon, the program code comprising:
program code to receive a message indicative of a timing relationship between a Global System for Mobile communications (GSM) frame and a Time Division-Synchronous Code Division Multiple Access (TD-SCDMA) frame.

19. The computer readable medium of claim 18, further comprising program code to acquire a GSM signal from at least one GSM cell based on the message.

20. The computer readable medium of claim 18, in which the timing relationship indicates a frame number in a Frequency Correction Channel (FCCH)/Synchronization Channel (SCH) cycle corresponding to a next TD-SDMA subframe frame number (SFN)=0.

21. The computer readable medium of claim 19, further comprising program code to hand over to a selected GSM cell based on the acquiring.

22. The computer readable medium of claim 21, in which the acquiring measures strength, timing, and frequency of the GSM signal.

23. The computer readable medium of claim 21, in which the acquiring obtains Base Station Identity Code information.

24. A computer readable medium having program code recorded thereon, the program code comprising:
program code to obtain a timing relationship between a Global System for Mobile communications (GSM) frame and a time division-synchronous code division multiple access (TD-SCDMA) frame; and
program code to transmit a message indicative of the timing relationship between the GSM frame and the TD-SCDMA frame.

25. An apparatus for wireless communication in a time division-synchronous code division multiple access (TD-SCDMA) system, the apparatus comprising:
means for receiving a message indicative of a timing relationship between a Global System for Mobile communications (GSM) frame and a Time Division-Synchronous Code Division Multiple Access (TD-SCDMA) frame; and
means for acquiring a GSM signal from at least one GSM cell based on the message.

26. The apparatus of claim 25, in which the timing relationship indicates a frame number in a Frequency Correction Channel (FCCH)/Synchronization Channel (SCH) cycle corresponding to a next TD-SDMA subframe frame number (SFN)=0.

27. The apparatus of claim 25, further comprising means for handing over to a selected GSM cell based on the acquiring.

28. The apparatus of claim 25, in which the acquiring means measures strength, timing, and frequency of the GSM signal.

29. The apparatus of claim 25, in which the acquiring means obtains Base Station Identity Code information.

30. An apparatus for wireless communication in a time division-synchronous code division multiple access (TD-SCDMA) system, the apparatus comprising:
means for obtaining a timing relationship between a Global System for Mobile communications (GSM) frame and a TD-SCDMA frame; and
means for transmitting a message indicative of the timing relationship between the GSM frame and the TD-SCDMA frame.

31. The apparatus of claim 30, in which the timing relationship obtaining means comprises a GSM mobile station.

32. The apparatus of claim 31, in which the GSM mobile station is installed in the Node B.
